(19) United States
(12) Patent Application Publication
(10) Pub. No.: US 2007/0152448 A1
(43) Pub. Date: Jul. 5, 2007

(54) Multiuse electric power generating device

(76) Inventors: Stuart O. Goldman, Scottsdale, AZ (US); Richard E. Krock, Naperville, IL (US); Karl F. Rauscher, Emmaus, PA (US); James P. Runyon, Wheaton, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2579, US

(21) Appl. No.: 11/323,636

(22) Filed: Dec. 30, 2005

(51) Int. Cl. H02K 7/18; F03G 7/08; F02B 63/04

(52) U.S. Cl. 290/1 R

(57) ABSTRACT

An electrical power generating device (10) is provided for supplying electrical power to a charger of a rechargeable electronic device. Suitably, the charger has a connector at one end adapted to interface with the rechargeable electronic device and has at another end a standard electrical plug. The electrical power generating device (10) includes: an electric generator (12) that generates electrical power when driven; and, a receptacle (30) which receives electrical power from the generator (12). The receptacle (30) is provisioned with a standard electrical outlet (34) adapted to fit the standard electrical plug of the charger such that the electrical power received by the receptacle (30) from the electric generator (12) is output through the standard electrical outlet (34).

### FIELD

The present inventive subject matter relates to the electrical arts. Particular application is found in conjunction with handheld and/or portal electronic devices such as a mobile telephone, a laptop or notebook computer, a PDA (Personal Digital Assistant), a portable radio or television, a GPS (Global Positioning System) receiver or tracking device, etc. While the specification makes particular reference thereto, it is to be appreciated that aspects of the present inventive subject matter are also amenable to other like applications.

### BACKGROUND

Many portable and/or handheld electronic devices (e.g., mobile telephones, laptop or notebook computers, portable radio receivers and/or handheld radio transmitters, PDAs, GPS devices, etc.) are rechargeable devices, e.g., powered by rechargeable batteries. When the batteries are discharged, the electronic devices become inoperable until they or their batteries are sufficiently recharged. For this purpose then, typically, each device comes with its own distinct charger. More specifically, the charger and electronic device are typically equipped with a mated pair of male and female or other like connectors (one of the pair arranged on the charge and the other on the device) by which the charger and device are selectively joined or engaged with one another to recharge the device and/or the batteries in the device. The other end of the charger (i.e., the end not connected to the electronic device) is typically equipped or provisioned with a standard plug or the like that is designed and/or arranged to fit a standard electrical power outlet or socket such as, e.g., a standard 12 V DC automotive electric power outlet (a.k.a., a standard automobile cigarette lighter socket), a standard North American 120 V AC wall outlet, a standard European wall outlet, etc. Accordingly, when the charger and device are joined together or otherwise engaged with one another and the charger is plugged into a standard outlet or socket at its other end, the device and/or the device's batteries are recharged.

However, the use of a charger in the foregoing manner has certain limitations. For example, commonly, the connectors used to interface the device and charger with one another are unique to that device-charger pair. Accordingly, a charger from one device often cannot be used to recharge another device because the connectors are not designed or arranged to mate correctly or otherwise fit together. Additionally, using a charger in the forgoing manner assumes that there is electrical power available from the standard outlet or socket into which the charger is plugged. In many cases, however, conventional electrical power sources may be dead, offline or otherwise unavailable. For example, a natural disaster or other disturbance may have disrupted or shut down the conventional electric power grid in a given region; an automobile otherwise used as a power source may have run out of fuel; the portable electronic device may be located in a remote region where electrical power is not readily available from a conventional or fixed source; etc. Moreover, it is in just such instances (i.e., emergencies) that one may most appreciate the ability to recharge dead or discharged batteries and/or to provide electrical power for an otherwise inoperative electronic device.

To address the forgoing problem, there are various options. For example, replacement or backup batteries for the electronic device may be kept on hand in the case of an emergency. However, these backup or replacement batteries may only have a limited shelf-life and when ultimately used they will still only have a limited operational lifetime that may not be sufficiently long in some circumstances. Moreover, different electronic devices often use different types of batteries (i.e., with different physical sizes and/or shapes, and/or different voltage or amperage ratings, etc.). Accordingly, it may be unduly burdensome to maintain a reserve or backup supply or inventory of all the different types of batteries for all the different electronic devices an individual may want to use in an emergency situation.

As another option, some portable electronic devices have been developed with an integrated hand driven or manually powered electric generator. These electric generators, however, only provide electric power to the device with which they are integrated. Other electronic devices are still vulnerable to running out of electric power and risk becoming inoperable absent a suitable source of electric power to recharge and/or power them. Moreover, integrating a hand driven or manually powered electric generator into an electronic device tends to add bulk and/or weight to the overall device thereby negatively impacting its attractiveness as a portable or handheld device. For example, an integrated hand driven or manually powered electrical generator is generally not practical for devices such as mobile telephones, PDAs, laptop or notebook computers, etc. insomuch as the added bulk and/or weight tends to detract from the portable, handheld and/or mobile nature of the devices. Additionally, relatively more delicate electronic devices or relatively more delicate components thereof may not be well suited to the mechanical stresses and/or vibrations that may be introduced by the manual operation of an integrated electric generator.

Of course, other so called backup electric generators are also known. These electric generators, however, are often too big, bulky and/or heavy for many applications and/or in many instances are not sufficiently portable for casual or impromptu use. Simply put, these types of electric generators are often overkill or too much generator for the job. Additionally, such generators typically run on gasoline or some other similar fuel, and accordingly, their usefulness is limited by the availability of this fuel. For example, in some situations, the fuel needed to run the electric generator maybe in short supply or unattainable. More specifically, in a large natural disaster or other catastrophe, for example, gas stations or other fuel pumping facilities may be shut down or inoperable thereby restricting access to fuel reserves. Accordingly, absent the availability of additional fuel, once any fuel on hand has been exhausted, an electric generator that runs on the fuel can no longer be used to power or recharge the electronic devices one may wish to use.

Accordingly, a new and improved multiuse electric power generating device and/or method for powering and/or recharging diverse electronic devices is disclosed that overcomes the above-referenced problems and others.

### SUMMARY

In accordance with one embodiment, an electrical power generating device is provided for supplying electrical power to a charger of a rechargeable electronic device. Suitably, the charger has a connector at one end adapted to interface with the rechargeable electronic device and has at another end a standard electrical plug. The electrical power generating device includes: an electric generator that generates electrical power when driven; and, a receptacle which receives electrical power from the generator. The receptacle is provisioned with a standard electrical outlet adapted to fit the standard electrical plug of the charger such that the electrical power received by the receptacle from the electric generator is output through the standard electrical outlet.

In accordance with another embodiment, a method for supplying electrical power to a charger of a rechargeable electronic device is provided. Suitably, the charger has a connector at one end adapted to interface with the rechargeable electronic device and has at another end a standard electrical plug. The method includes: driving an electric generator to produce electrical power; and, supplying the produced electrical power to a receptacle that is provisioned with a standard electrical outlet adapted to fit the standard electrical plug of the charger. Ultimately, the electrical power supplied to the receptacle is output through the standard electrical outlet.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration of an exemplary multiuse electric power generating device embodying aspects of the present inventive subject matter.

FIG. 2 is a diagrammatic illustration of an exemplary wind powered drive for the multiuse electric power generating device shown in FIG. 1.

### DETAILED DESCRIPTION

For clarity and simplicity, the present specification shall refer to structural and/or functional elements, entities and/or facilities, relevant standards, protocols and/or services, and other components and features that are commonly known in the art without further detailed explanation as to their configuration or operation except to the extent they have been modified or altered in accordance with and/or to accommodate the embodiment(s) presented herein.

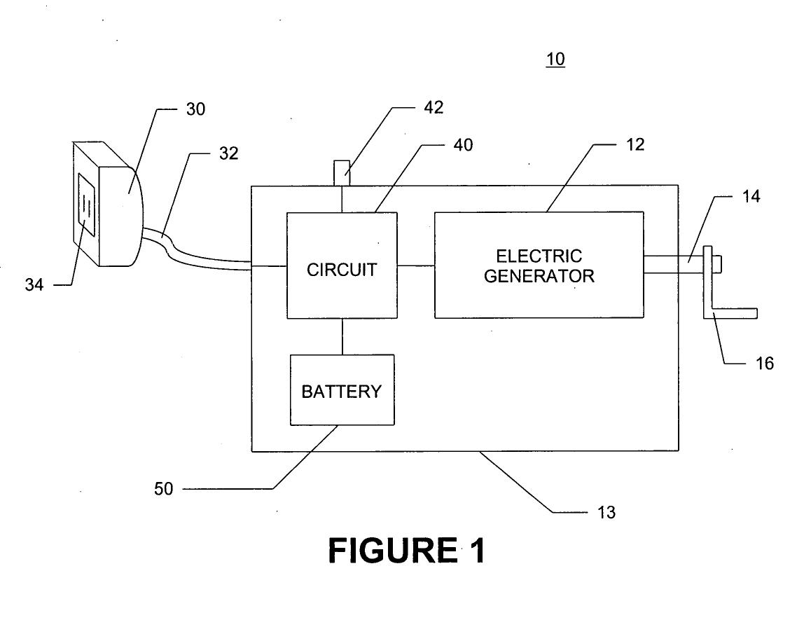

With reference to FIG. 1, a multiuse electric power generating device 10 includes an electric generator 12, e.g., containing in a housing 13. Suitably, the electric generator 12 is a dynamo, a Gramme or some other version of a dynamo, an alternator, or any other suitable type of electric generator as is known in the art. In the illustrated example, the electric generator 12 produces electrical power in response to and/or is driven by the rotation of a rotor shaft 14 that is operatively coupled to the electric generator 12. However, alternate mechanical arrangements and/or movements are optionally employed to drive the electric generator 12 to produce electrical power therefrom.

Suitably, the multiuse electric power generating device 10 has sufficient power generating capacity for and is equipped to power the chargers of various diverse types of rechargeable handheld and/or portable electronic devices such as mobile telephones, laptop or notebook computers, portable radio receivers and/or handheld radio transmitters, PDAs, GPS devices, and other similar personal electronic devices, e.g., which have rechargeable batteries that are normally recharged via a charger designed for the particular device and adapted to plug into a standard electrical outlet or socket. In one exemplary embodiment, the device 10 is portable, e.g., with the housing 13 taking the form of cube or other shape on the order of approximately 4 inches per side and weighing less than approximately 10 pounds. While the foregoing is deemed a reasonable tradeoff between size, weight and power generating capacity, it is to be appreciated that other dimensions, shapes, weights, power generating capacities, etc. are also contemplated.

Suitably, the electric generator 12 is hand driven or manually powered. For example, as shown in FIG. 1, a crank or handle 16 is attached to the rotor shaft 14 that is operatively coupled to the electric generator 12. Manually turning the crank or handle 16 rotates the shaft 14 thereby driving the electric generator 12 to produce electric power.

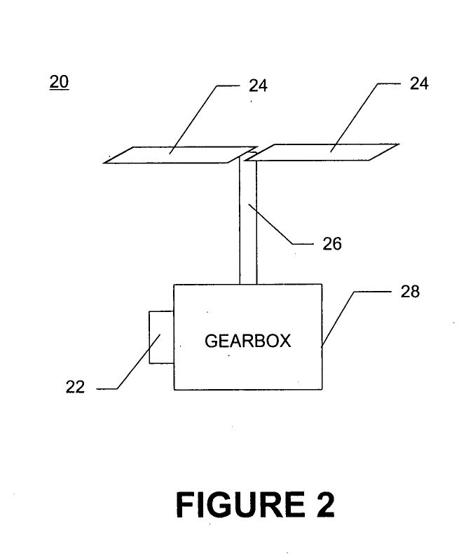

With reference to FIG. 2, an optional wind powered turbine or wind drive 20 is provided for driving the electric generator 12. Optionally, the handle 16 is selectively detached form the shaft 14 and the wind drive 20 is selectively attached to the shaft 14 via a mechanical coupling 22. For example, as shown in FIG. 2, the wind drive 20 includes a propeller or a set of wind cups, blades or other wind-catching armatures 24 that are operatively connected or attached to a drive shaft 26. Suitably, the drive shaft 26 is operatively coupled to the coupling 22 through a set of suitable gears housed in a gearbox 28 so that when the drive shaft 26 is rotated by the armatures 24 due to the blowing of wind on the armatures 24, the coupling 22 is in turn rotated with sufficient force or toque to drive the electric generator 12 connected to the coupling 22 via the rotor shaft 14, thereby producing electric power from the electric generator 12. Accordingly, if a user desires to manually drive the electric generator 12, then the wind drive 20 is detached from the rotor shaft 14 and the handle 16 is attached to the rotor shaft 14. Alternately, if the user desires to have the wind drive the electric generator 12, then the handle 16 is detached from the rotor shaft 14 and the wind drive 20 is attached to the rotor shaft 14. Alternately, the wind drive 20 is optionally arranged to connect to the handle 16 and turn the same thereby rotating the shaft 14.

With reference again to FIG. 1, the electrical power produced by the electric generator 12 is delivered to a receptacle 30 where it is available for output from the device 10. In the illustrated example, the receptacle 30 is connected to the device 10 and/or housing 13 via a flexible cord 32 containing appropriate conductors and/or wires suitable for transporting the electrical power that passes therethrough. As shown, the receptacle 30 is provisioned with and/or includes a standard outlet or socket 34. Suitable standard outlets and/or sockets include, e.g., standard NEMA, IEC, CEE and/or JIS electrical power outlets and/or sockets, standard 12 V DC automotive electric power outlets (a.k.a., a standard automobile cigarette lighter socket) or other standard DC outlets and/or sockets, standard North American 120 V AC wall outlets, standard European wall outlets or other standard International wall outlets, etc. Accordingly, the receptacle 30 is arranged to receive the corresponding standard plug found on many conventional chargers for rechargeable electronic devices. Notably, the multiuse electric power generating device 10 is not intended to replace the charger of any particular rechargeable electronic device. Rather, the standard outlet or socket 34 allows the device 10 to be used in conjunction with and/or to power any charger having a matching standard plug, and hence the device 10 can provide the electrical power to recharge a number of diverse types of rechargeable electronic devices without having to duplicate each of a plurality of different interfaces specific and/or unique to those different electronic devices. Additionally, the flexible cord 32 allows the receptacle 30 to move freely (i.e., independently of the housing 13 and/or the rest of the device 10) thereby aiding in insulating any charger and/or its associated electronic device that may be connected and/or plugged into the receptacle 30 from vibrations and/or mechanical stresses that might be introduced by the manual driving of the electric generator 12.

Suitably, as shown in FIG. 1, the device 10 is equipped with a conditioning circuit 40 operatively arranged between the electric generator 12 and the receptacle 30. The circuit 40 conditions the electrical power produced by the electric generator 12 before it is delivered to the receptacle 30 so as to be in a form compatible with the kind or type of standard outlet or socket 34 that is being used. That is to say, the circuit 40 optionally adjusts the voltage, current and/or waveform shape of the electric power produced by the electric generator 12 so as to fall within acceptable parameters designated for the standard outlet or socked 34 equipped in the receptacle 30. For example, if the electric generator 12 produces AC (Alternating Current) power and the standard outlet or socket 34 equipped in the receptacle 30 is designated for DC (Direct Current) power, the conditioning circuit 40 rectifies the current with an appropriate rectifier or the like and an optional smoothing circuit. Conversely, yet in a similar fashion, the condition circuit 40 optionally converts DC power output from the generator 12 to AC power which is then delivered to the receptacle 30 if the configuration of the device 10 so demands. Of course, if the generator 12 already produces the form of power (i.e., DC or AC) that is to be used at the receptacle 30, then the conversion is omitted from the conditioning circuit 40.

Additionally, the circuit 40 also optionally filters out noise that may be present in the generated electrical power, e.g., as a result of the manual and/or inconsistent driving of the electric generator 12. However, since it is contemplated that the electronic devices being recharged are commonly battery operated, the acceptable noise tolerances are somewhat relaxed from what they would be if the electronic devices were being operated directly from the power generated by the device 10.

In one optional embodiment, the receptacle 30 is provisioned with and/or includes a plurality of standard outlets or sockets 34. In this manner, the receptacle 30 optionally accommodates a number of different standard plugs making the multiuse electric power generating device 10 even more flexible. As illustrated, an optional switch 42 is provided by which a user selects the specific outlet 34 being used in a given instance. Suitably, the switch 42 controls or regulates the operation of the condition circuit 40 to achieve the desired form of electrical power being delivered to the receptacle 30, i.e., so that it is compatible with standard outlet 34 being used in the particular instance. Alternately, the switch 42 optionally selects between a plurality of different conditioning circuits 40 corresponding to the plurality of different standard outlets 34 provisioned in the receptacle 30. That is to say, e.g., one circuit 40 optionally conditions the electrical power output from the generator 12 to be compatible with one of the standard outlets 34 in the receptacle 30, while another different circuit 40 conditions the electrical power output from the generator 12 to be compatible with another different standard outlet 34 in the receptacle 30, and the switch 42 selects which one of the two circuits 40 the electrical power from the generator 12 is routed through and to which one of the two outlets 34 in the receptacle 30 it is delivered.

In yet another optional embodiment, the multiuse electric power generating device 10 is also equipped with a battery 50 that stores generated electrical power from the generator 12 until it is desired to be output from the receptacle 30. Suitably, the switch 42 also controls the charging and discharging of the battery 50. That is to say, e.g., optionally when the switch 42 is in one given position, electrical power from the generator 12 is directed and/or routed to the battery 50, optionally, through the conditioning circuit 40 which in the selected mode prepares the power or otherwise makes it compatible for charging the battery 50. When the switch 42 is moved to another given position, the battery 50 discharges its stored electrical energy which is routed (optionally, again through the circuit 40 for appropriate conditioning) to the receptacle 30 where the electrical power is available to be used as desired. Optionally, the battery 50 charges and/or discharges automatically depending upon the amount of electrical power that is being produced by the generator 12 and/or the load connected to the receptacle 30 at any given time. That is to say, if there is an otherwise excess or surplus of electrical power (i.e., electrical power which is not being used at the time) being produced by the generator 12, then this surplus automatically charges the battery 50, while on the other hand, if there is a deficiency in electrical power being produced by the generator 12 (i.e., less than can be handled by the load connected to the receptacle 30), then the battery 50 automatically discharges its reserved electrical power to the extent available to make up the difference.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. An electrical power generating device for supplying electrical power to a charger of a rechargeable electronic device, said charger having a connector at one end adapted to interface with the rechargeable electronic device and having at another end a standard electrical plug, the electrical power generating device comprising:
an electric generator that generates electrical power when driven; and,
a receptacle which receives electrical power from the electric generator, said receptacle being provisioned with a standard electrical outlet adapted to fit the standard electrical plug of the charger, said electrical power received by the receptacle from the electric generator being output through the standard electrical outlet.

2. The electrical power generating device of claim 1, further comprising:
a handle operatively connected to the electric generator such that the electric generator is manually driven by operation of the handle.

3. The electrical power generating device of claim 1, further comprising:
a wind powered turbine operatively connected to the electric generator such that the electric generator is driven by the wind powered turbine.

4. The electrical power generating device of claim 1, wherein the standard outlet is one of a standard North American 120 V AC wall outlet, a standard 12 V DC automotive cigarette lighter socket, or a standard International wall outlet.

5. The electrical power generating device of claim 1, wherein the electrical power generating device is portable.

6. The electrical power generating device of claim 1, wherein the receptacle is arranged at an end of a flexible cord so that the receptacle is free to move independently of the rest of the electrical power generating device.

7. The electrical power generating device of claim 1, further comprising:
a circuit operatively arranged between the electric generator and the receptacle, said circuit conditioning the electrical power output from the electric generator so as to be compatible with the standard outlet provided in the receptacle.

8. The electrical power generating device of claim 1, wherein the receptacle is provisioned with a plurality of different standard electrical outlets adapted to fit a plurality of different standard electrical plugs such that the electrical power generating device is compatible with a plurality of different chargers for a plurality of different rechargeable electronic devices.

9. The electrical power generating device of claim 1, further comprising:
a battery that selectively stores electrical power from electric generator and selectively delivers it the receptacle.

10. A method for supplying electrical power to a charger of a rechargeable electronic device, said charger having a connector at one end adapted to interface with the rechargeable electronic device and having at another end a standard electrical plug, the method comprising:
driving an electric generator to produce electrical power; and,
supplying the produced electrical power to a receptacle, said receptacle being provisioned with a standard electrical outlet adapted to fit the standard electrical plug of the charger, said electrical power supplied to the receptacle being output through the standard electrical outlet.

11. The method of claim 10, further comprising:
conditioning the electrical power produced by the electric generator so as to be compatible with the standard outlet provided in the receptacle.

12. The method of claim 11, wherein the conditioning includes at least one of converting AC power to DC power or converting DC power to AC power.

13. The method of claim 10, wherein the electric generator is manually driven.

14. The method of claim 10, wherein the electric generator is driven by a wind powered turbine.

15. The method of claim 10, wherein the standard outlet is one of a standard North American 120 V AC wall outlet, a standard 12 V DC automotive cigarette lighter socket, or a standard International wall outlet.
